(19) United States
(12) Patent Application Publication
(10) Pub. No.: US 2026/0227194 A1
(43) Pub. Date: Aug. 6, 2026

(54) VIDEO PREVIEW NAVIGATION SYSTEM AND CONTROL METHOD FOR VIDEO PREVIEW NAVIGATION SYSTEM

(71) Applicant: TOYOTA JIDOSHA KABUSHIKI KAISHA, Toyota-shi (JP)

(72) Inventor: Anil SHENOY, Tokyo (JP)

(73) Assignee: TOYOTA JIDOSHA KABUSHIKI KAISHA, Toyota-shi (JP)

(21) Appl. No.: 19/379,110

(22) Filed: Nov. 4, 2025

(30) Foreign Application Priority Data
Feb. 5, 2025 (JP) 2025-017408

(51) Int. Cl. G01C 21/36

(52) U.S. Cl. CPC G01C 21/3647

(57) ABSTRACT

A video preview navigation system has a server communicably connected to a plurality of communication vehicles. The server includes a data acquisition unit configured to, when a first guided route is set in the first vehicle and the first vehicle passes through a preset driving decision point on the first guided route, acquire video data captured by a front camera of the first vehicle at the driving decision point, information of the driving decision point, and information of the first guided route. The server also includes a data providing unit configured to, when a second guided route that at least partially overlaps with the first guided route is set in a second vehicle, provide the video data at the driving decision point to the second vehicle when the second vehicle heads toward the driving decision point where an overlapping route has a matching direction of passage.

### CROSS-REFERENCE TO RELATED APPLICATIONS

This application is based upon and claims the benefit of priority from Japanese Patent Application No. 2025-017408, filed on February 5, 2025, the entire contents of which are incorporated herein by reference.

### TECHNICAL FIELD

The present disclosure relates to a video preview navigation system and a control method for the video preview navigation system.

### BACKGROUND

Conventionally, Japanese Unexamined Patent Application Publication No. H05-240724 is known as a technical document related to a video preview navigation system. This publication describes a navigation device that records video data captured of a real view around a vehicle in association with positioning information of the vehicle determined by a GPS receiver of the vehicle. In this device, when a vehicle is guided along the same route as a route for which video was captured in the past, and the vehicle approaches a position such as an intersection or a branch road where a driver is likely to make a mistake in the driving route, the video data recorded in the past is displayed on a display device inside the vehicle.

### SUMMARY

However, a conventional navigation device can only provide video data on a route that the host vehicle has traveled in the past. For this reason, video data is not provided at a branch road or the like where the host vehicle travels for the first time, and there has been a risk that the driver may mistake the route to be traveled.

One aspect of the present disclosure is a video preview navigation system having a server communicably connected to a plurality of communication vehicles including a first vehicle and a second vehicle. The server includes: a data acquisition unit configured to, when a first guided route is set in the first vehicle and the first vehicle passes through a preset driving decision point on the first guided route, acquire video data captured by a front camera of the first vehicle at the driving decision point, information of the driving decision point, and information of the first guided route; and a data providing unit configured to, when a second guided route that at least partially overlaps with the first guided route is set in the second vehicle, provide the video data at the driving decision point to the second vehicle when the second vehicle heads toward the driving decision point where the overlapping routes have a matching direction of passage.

According to the video preview navigation system of the present disclosure, by acquiring the video data captured by the front camera, the information of the driving decision point, and the information of the first guided route when the first vehicle passes through the preset driving decision point on the first guided route, road conditions can be accurately recorded. Furthermore, according to this video preview navigation system, when the second vehicle travels on a second guided route that at least partially overlaps with the first guided route, and the overlapping route heads toward a driving decision point where the direction of passage matches, by providing the video data at the driving decision point to the second vehicle, the driver of the second vehicle can visually confirm the situation at the driving decision point in advance. Therefore, according to this video preview navigation system, it is possible to provide video data that can appropriately support the judgment of the driving operation of the driver of the second vehicle at the driving decision point.

The video preview navigation system according to one aspect of the present disclosure may further include a car navigation device mounted on the second vehicle and configured to provide the video data to the driver of the second vehicle in a picture-in-picture mode on a display of the second vehicle.

In the video preview navigation system according to one aspect of the present disclosure, the data providing unit executes a privacy protection process to delete privacy information included in the video data before providing the video data to the second vehicle, and in the privacy protection process, at least information of a license plate of another vehicle traveling in front of the first vehicle may be deleted.

In the video preview navigation system according to one aspect of the present disclosure, the data providing unit may adjust a transmission timing of the video data such that the video data at the driving decision point is provided to the second vehicle before the second vehicle reaches the driving decision point, based on a data size of the video data to be provided, a network communication state of the server and the second vehicle, and an estimated time of arrival of the second vehicle at the driving decision point.

In the video preview navigation system according to one aspect of the present disclosure, the driving decision point may include at least one of an entrance of a branch road, an interchange, a roundabout, a multi-lane tunnel, and toll booths provided in each of a plurality of lanes.

Another aspect of the present disclosure is a control method for a video preview navigation system having a server communicably connected to a plurality of communication vehicles including a first vehicle and a second vehicle. This control method for the video preview navigation system comprises: acquiring, when a first guided route is set in the first vehicle and the first vehicle passes through a preset driving decision point on the first guided route, video data captured by a front camera of the first vehicle at the driving decision point, information of the driving decision point, and information of the first guided route; and providing, when a second guided route that at least partially overlaps with the first guided route is set in the second vehicle, the video data at the driving decision point to the second vehicle when the second vehicle heads toward the driving decision point where an overlapping route has a matching direction of passage.

According to the control method for the video preview navigation system of another aspect of the present disclosure, by acquiring the video data captured by the front camera, the information of the driving decision point, and the information of the first guided route when the first vehicle passes through the preset driving decision point on the first guided route, road conditions can be accurately recorded. Furthermore, according to this control method for the video preview navigation system, when the second vehicle travels on a second guided route that at least partially overlaps with the first guided route, and the overlapping route heads toward a driving decision point where the direction of passage matches, by providing the video data at the driving decision point to the second vehicle, the driver of the second vehicle can visually confirm the situation at the driving decision point in advance. Therefore, according to this control method for the video preview navigation system, it is possible to provide video data that can appropriately support the judgment of the driving operation of the driver of the second vehicle at the driving decision point.

According to each aspect of the present disclosure, it is possible to provide video data that can appropriately support the judgment of the driving operation of the driver of the second vehicle at the driving decision point.

### BRIEF DESCRIPTION OF THE DRAWINGS

FIG. 1 is a diagram illustrating a video preview navigation system according to an embodiment.

FIG. 2 is a block diagram illustrating an example of a functional configuration of a server and a communication vehicle of the video preview navigation system.

FIG. 3 is a diagram illustrating an example of providing video data in a second vehicle.

FIG. 4A is a flowchart illustrating an example of a data transmission process of a first vehicle.

FIG. 4B is a flowchart illustrating an example of a data processing process of the server.

FIG. 5A is a flowchart illustrating an example of a data request process of a second vehicle.

FIG. 5B is a flowchart illustrating an example of a data providing process of the server.

### DETAILED DESCRIPTION

Hereinafter, embodiments of the present disclosure will be described with reference to the drawings.

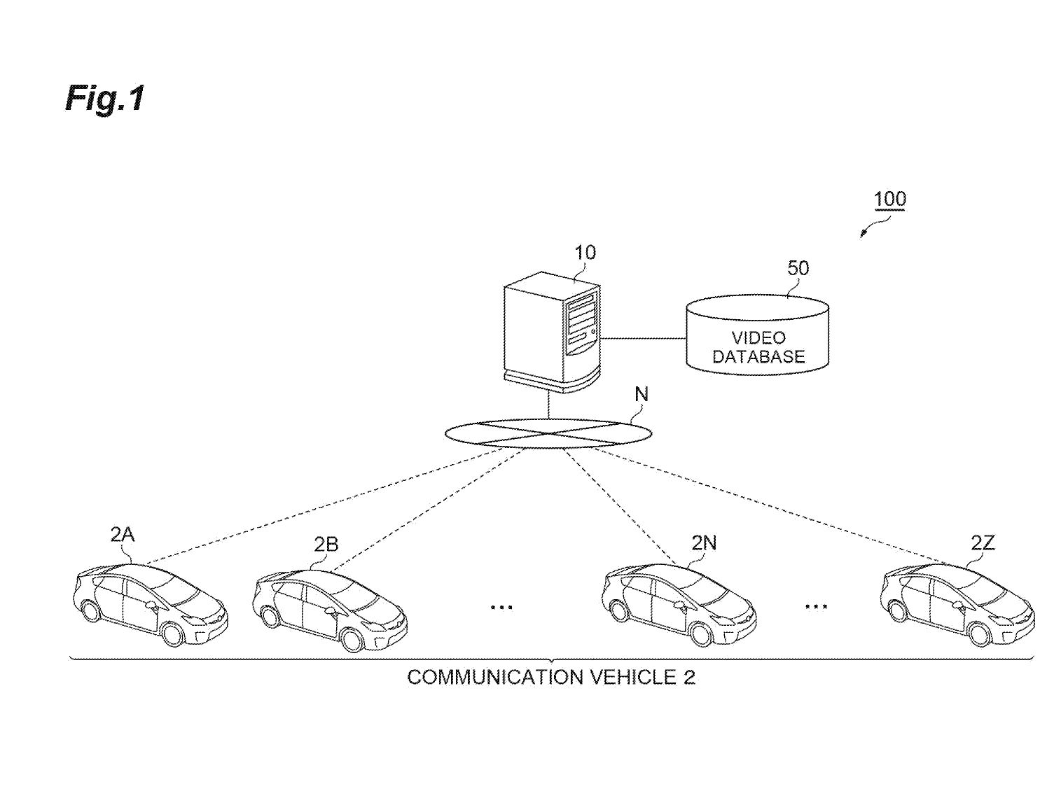

FIG. 1 is a diagram illustrating a video preview navigation system 100 according to an embodiment. The video preview navigation system 100 shown in FIG. 1 is intended to provide video data at specific driving decision points to enhance vehicle navigation. The video preview navigation system 100 supports appropriate driving judgment by a driver by providing, in advance, video data captured by a preceding vehicle at driving decision points such as complex road environments, or branch roads and intersections that the driver is passing through for the first time.

### Configuration of Video Preview Navigation System

As shown in FIG. 1, the video preview navigation system 100 is a system having a server 10 communicably connected to a plurality of communication vehicles 2 (communication vehicles 2A to 2Z) via a network N. The network N is not particularly limited as long as it is a wireless communication network capable of exchanging information. The network N may be the Internet, a communication network for mobile terminals, or a communication network for road-to-vehicle communication. In addition, the server 10 is connected to a video database 50, stores video data transmitted from the plurality of communication vehicles 2, and provides the video data to other communication vehicles 2 as necessary.

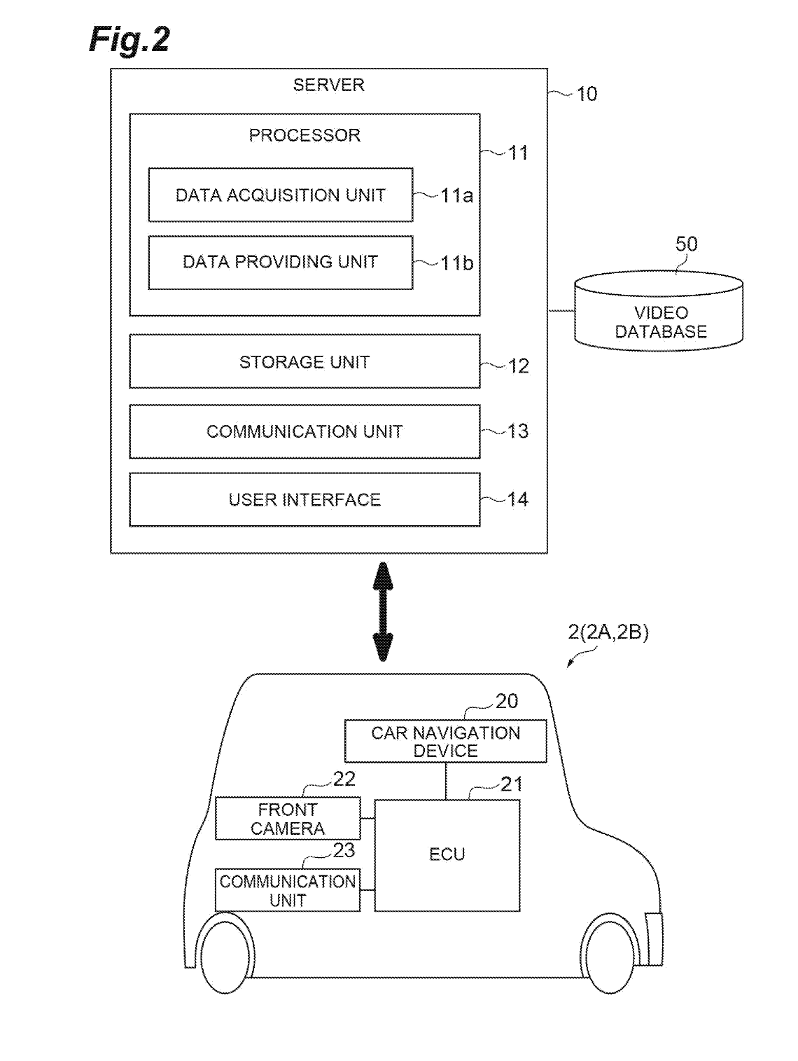

FIG. 2 is a block diagram illustrating an example of a functional configuration of the server 10 and the communication vehicle 2A of the video preview navigation system 100. As shown in FIG. 2, the server 10 is configured as a general computer including a processor 11, a storage unit 12, a communication unit 13, and a user interface 14. The user in this case means an administrator or the like of the server 10.

The processor 11 controls the server 10 by operating various operating systems. The processor 11 is an arithmetic unit such as a CPU (Central Processing Unit) including a control device, an arithmetic device, a register, and the like. The processor 11 supervises the storage unit 12, the communication unit 13, and the user interface 14. The storage unit 12 is configured to include at least one of a memory and a storage. The memory is a recording medium such as a ROM (Read Only Memory), a RAM (Random Access Memory), or an EEPROM (Electrically Erasable Programmable Read-Only Memory). The storage is a recording medium such as an HDD. The storage unit 12 may be configured to be able to temporarily store data to be recorded in the video database 50 and data acquired from the video database 50.

The communication unit 13 is a communication device for performing communication via the network N. For the communication unit 13, a network device, a network controller, a network card, or the like can be used. The user interface 14 is an input/output unit of the server 10 for a user such as an administrator. The user interface 14 includes an output device such as a display and a speaker, and an input device such as a touch panel.

The video database 50 is a database for storing video data acquired from the communication vehicles 2. The video database 50 is connected to the server 10 and is controlled by the processor 11.

Note that the server 10 does not necessarily need to be provided in a facility, and may be mounted on a vehicle or other moving object. The server 10 may be formed on a cloud network. The functional configuration of the processor 11 of the server 10 will be described later.

Next, a first vehicle 2A, which is a representative example of a vehicle that transmits video data to the server 10 among the plurality of communication vehicles 2, will be described.

The first vehicle 2A includes a car navigation device 20, an ECU (Electronic Control Unit) 21, a front camera 22, and a communication unit 23. The car navigation device 20 is a device that calculates a route for the first vehicle 2A to reach a destination from a current position of the first vehicle 2A and a preset destination. The car navigation device 20 provides visual and audible guidance to the driver using a display and a speaker of the first vehicle 2A.

The ECU 21 is an electronic control unit having a CPU and a storage unit. The storage unit is composed of, for example, a ROM, a RAM, an EEPROM, or the like. In the ECU 21, for example, various functions are realized by executing a program stored in the storage unit with the CPU. The ECU 21 may be composed of a plurality of electronic units.

The front camera 22 is an imaging device that captures a situation in front of the first vehicle 2A. The front camera 22 is provided, for example, on a back side of a windshield of the first vehicle 2A and captures an image of the front of the first vehicle 2A. The front camera 22 transmits the captured image of the front of the first vehicle 2A to the ECU 21.

The communication unit 23 is a device for performing communication between the first vehicle 2A and the server 10. The communication unit 23 realizes bidirectional data communication between various devices in the vehicle and the server 10. Furthermore, the communication unit 23 also has a function for ensuring security in data transmission and reception. The data communication is encrypted to prevent unauthorized access and data tampering. In addition, the communication unit 23 uses an authentication protocol to realize highly reliable communication between the communication vehicle 2 and the server 10.

Subsequently, transmission of video data in the first vehicle 2A will be described. In the first vehicle 2A, when a route guided by the car navigation device 20 (hereinafter referred to as a first guided route) is set, driving decision points on the first guided route are extracted.

The driving decision point is a point preset in the video preview navigation system 100 as a location where the driver needs to pay attention to driving judgment. The driving decision point is set in association with position information or map information. Even for the same point, it may be treated as a driving decision point or not treated as a driving decision point, depending on the approach direction. Even for the same point, an aspect may be adopted in which it is not treated as a driving decision point if a lane change or a right/left turn is not necessary in the current first guided route.

The driving decision point includes at least one of an entrance of a branch road, an interchange, a roundabout, a multi-lane tunnel, and toll booths provided in each of a plurality of lanes. These points require special attention because the driver needs to select a traveling direction or perform a lane change. For example, at an entrance of a branch road or an interchange, there are a plurality of traveling directions, and the driver needs to select an appropriate route. At a roundabout, merging with or branching from other vehicles occurs when passing through a circular intersection, and entry and exit at the appropriate timing is required. In a multi-lane tunnel or at a toll booth, a lane change or selection of an appropriate lane is necessary, which can cause confusion, especially for a driver passing through for the first time.

When the first vehicle 2A passes a driving decision point on the first guided route, the car navigation device 20 transmits video data captured by the front camera 22 of the first vehicle 2A at the driving decision point, information of the driving decision point, and information of the first guided route to the server 10. Note that the ECU 21 may perform the data transmission process instead of the car navigation device 20.

The video data of the first vehicle 2A at the driving decision point is video data captured by the front camera 22 of the first vehicle 2A when the first vehicle 2A travels through the driving decision point. The video data in this case refers to video segment data that is a part of the entire video data captured by the front camera 22. The video data at the driving decision point shows the situation in front of the first vehicle 2A when the first vehicle 2A travels through the driving decision point along the first guided route.

The information of the driving decision point includes information for identifying the driving decision point. The information for identifying the driving decision point may be an ID (identification) of the driving decision point, or may be position information of the driving decision point. The information of the driving decision point may include information on the type of the driving decision point (type such as intersection, branch point, tunnel, interchange, etc.).

The information of the first guided route is information of the first guided route on a map. A data format of route information in a general navigation system can be adopted. The information of the first guided route may include an approach direction and an exit direction at the driving decision point.

Subsequently, the functional configuration of the server 10 will be described. As shown in FIG. 2, the processor 11 of the server 10 has a data acquisition unit 11a and a data providing unit 11b.

The data acquisition unit 11a collects necessary data from the first vehicle 2A via the communication unit 13 in the video preview navigation system 100. The data acquisition unit 11a acquires video data captured by the front camera 22 when the first vehicle 2A passes through a driving decision point, through communication with the first vehicle 2A. The data acquisition unit 11a also acquires information of the driving decision point and information of the guided route. The data acquisition unit 11a stores the video data in the video database 50 together with the information of the driving decision point and the information of the first guided route.

The data acquisition unit 11a performs various processing processes on the video data. The data acquisition unit 11a may, for example, perform a process of adding appropriate metadata to the video data. The metadata includes a date and time when the video segment was captured, information for identifying the driving decision point, information of the first guided route at the time of capturing the video data, and the like.

Here, consider a case where the server 10 side grasps the information of the first guided route, such as when the first vehicle 2A is an autonomous driving vehicle or a remotely operated vehicle. In this case, the data acquisition unit 11a may acquire the video data at the driving decision point by requesting the video data at the driving decision point from the first vehicle 2A. In this case, since the information of the first guided route and the information of the driving decision point on the first guided route are grasped by the server 10, transmission of the route and driving decision point information from the first vehicle 2A may be unnecessary.

Furthermore, the data acquisition unit 11a may perform a filtering process to ensure the quality of the video data. For example, an image processing technique is used to remove noise from the video data and obtain a clear image. This improves the quality of the video preview provided to the driver and increases the accuracy of driving judgment.

The data acquisition unit 11a may perform a privacy protection process. The acquired video data may include privacy information such as license plates of other vehicles and faces of people. The data acquisition unit 11a may be provided with a function to appropriately process this privacy information and delete it as necessary. Alternatively, the data providing unit 11b may perform the privacy protection process instead of the data acquisition unit 11a.

Specifically, the data acquisition unit 11a deletes images of license plates of other vehicles included in the video data of the first vehicle 2A. The deletion of the license plate images also includes a process of making them unrecognizable by masking. The license plate images are automatically detected and deleted using a specific algorithm or image processing technique. The same can be applied to images of faces of pedestrians or occupants of other vehicles. As a result, the video data is provided without identifying the license plates of other vehicles or the faces of people.

The data providing unit 11b provides necessary video data from the server 10 to a second vehicle 2B in the video preview navigation system 100. The second vehicle 2B is a representative example of a vehicle that is provided with video data of a driving decision point from the server 10 among the plurality of communication vehicles 2. The second vehicle 2B may also be on the data transmitting side (the role of the first vehicle 2A).

The data providing unit 11b provides the video data at an appropriate timing when the second vehicle 2B is heading toward a driving decision point. Specifically, when the second vehicle 2B travels on a second guided route that at least partially overlaps with the first guided route of the first vehicle 2A, and heads toward a driving decision point where the overlapping routes have a matching direction of passage, the data providing unit 11b provides the video data at the driving decision point to the second vehicle 2B.

The data providing unit 11b provides video data of a driving decision point on a second guided route on which the second vehicle 2B is traveling, in response to a video data request from the second vehicle 2B. The data providing unit 11b manages the video data stored in the video database 50 and identifies the video data to be provided based on the current position of the second vehicle 2B and the second guided route information.

When video data for the driving decision point to be provided is stored in the video database 50, that is, when the video data of the driving decision point on a route where the second guided route and a past first guided route overlap is stored in the video database 50, the data providing unit 11b transmits the video data of the driving decision point to the second vehicle 2B.

When video data for the driving decision point to be provided is not stored in the video database 50, that is, when the video data of the driving decision point on a route where the second guided route and a past first guided route overlap is not stored in the video database 50, the data providing unit 11b does not provide the data.

The data providing unit 11b may have a function of adjusting the transmission timing of the video data. The data providing unit 11b optimizes the transmission timing based on the data size, the network communication state of the server and the second vehicle 2B, and the estimated time of arrival of the second vehicle 2B at the driving decision point, so that the video data is reliably provided before the second vehicle 2B reaches the driving decision point.

Specifically, the data providing unit 11b grasps the data size of the video data in advance and monitors the network communication state of the server 10 and the second vehicle 2B in real time. The network communication state includes parameters such as communication speed, bandwidth, delay, and packet loss rate. The estimated time of arrival of the second vehicle 2B at the driving decision point is provided from the second vehicle 2B. Based on this information, the data providing unit 11b optimizes the transmission timing of the video data.

For example, when the data size of the video data is large, the data providing unit 11b adjusts the transmission timing by starting the data transmission early, so that the data reception is completed before the second vehicle reaches the driving decision point. In addition, when the network communication state is unstable or the communication speed is low, the data providing unit 11b can take measures such as dividing the data transmission. This makes it possible to minimize communication interruptions and delays, and to provide a smooth video preview to the driver.

Furthermore, when adjusting the transmission timing of the video data, the data providing unit 11b also considers the current position and traveling speed of the second vehicle. This makes it possible to predict the timing at which the second vehicle will reach the driving decision point and transmit the data accordingly. For example, when the second vehicle is traveling on an expressway, the time to reach the driving decision point is short, so the data providing unit 11b needs to transmit the data quickly. On the other hand, when traveling on a general road, there is more leeway in the transmission timing, so the transmission timing can be flexibly adjusted according to the network communication state.

The data providing unit 11b performs data communication with the second vehicle 2B via the communication unit 13. The communication unit 13 realizes high-speed and stable data communication, and enables the data providing unit 11b to quickly transmit necessary data.

Subsequently, providing of video data in the second vehicle 2B will be described. The configuration of the second vehicle 2B is assumed to have the same configuration as the first vehicle 2A as an example (see FIG. 2).

When a second guided route for guiding the second vehicle 2B is set, the car navigation device 20 of the second vehicle 2B extracts driving decision points on the second guided route. The car navigation device 20 transmits a video data request including the extracted information of the driving decision points and information of the second guided route to the server 10. When the information of the driving decision point includes the approach direction and the exit direction of the driving decision point, the information of the second guided route is not essential.

When the car navigation device 20 of the second vehicle 2B receives the video data of the driving decision point from the server 10, it provides the video data to the driver of the second vehicle 2B by displaying the video data of the driving decision point on the display of the car navigation device 20. The display may be a center display of the second vehicle 2B or a HUD (Head Up Display).

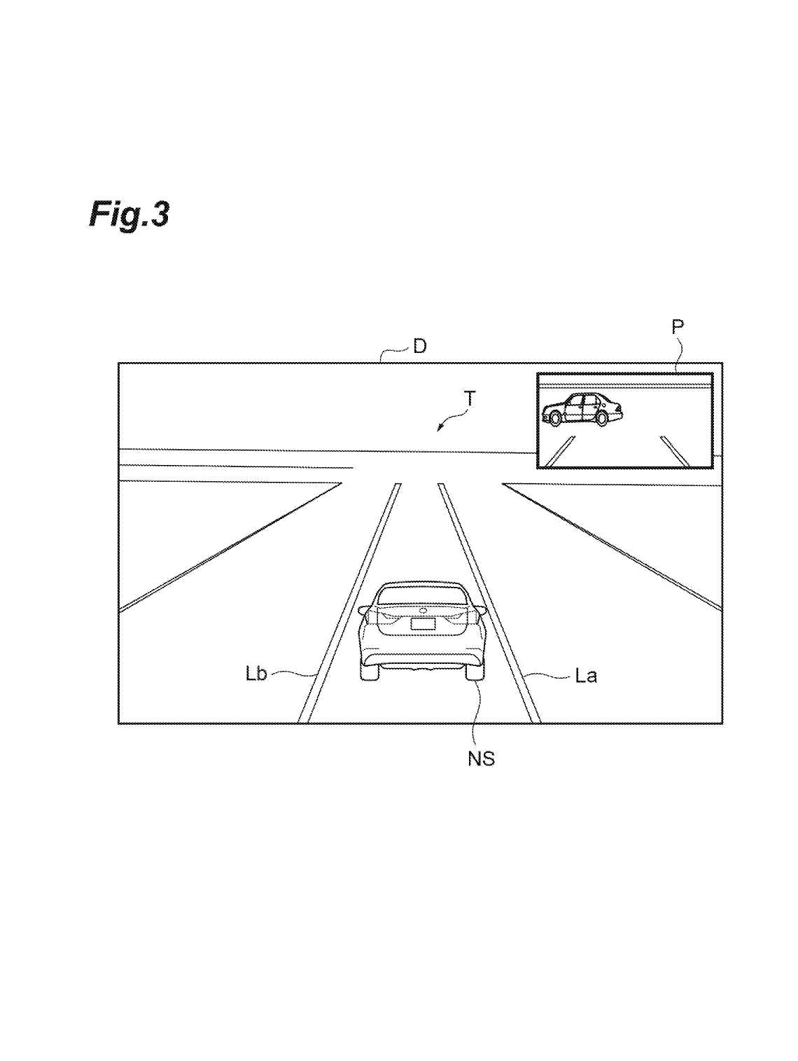

FIG. 3 is a diagram illustrating an example of providing video data in the second vehicle 2B. FIG. 3 shows a display D, a main screen, and a sub-screen P of the second vehicle 2B. In FIG. 3, a captured image from the front camera 22 of the second vehicle 2B is displayed on the main screen. The main screen shows a preceding vehicle NS of the second vehicle 2B, lane markings La and Lb of the lane in which the second vehicle 2B is traveling, and a T-shaped intersection T (driving decision point). The second guided route may be displayed on the main screen, and its display content is not particularly limited.

On the display D of the second vehicle 2B, in addition to the main screen, the sub-screen P can be displayed in a picture-in-picture mode (PiP mode). In FIG. 3, the car navigation device 20 displays the video data captured by the front camera 22 of the first vehicle 2A on the sub-screen P. The car navigation device 20 displays the video data at the intersection T, which is the next driving decision point for the second vehicle 2B to travel, in the picture-in-picture mode. In the video data, for example, when the second guided route turns left at the intersection T, the situation in front of the vehicle turning left at the intersection T is continuously displayed. Note that it is not always necessary to display the video data in the picture-in-picture mode, and it may be displayed on a display different from the display D or on a HUD.

By displaying a video preview of traveling through a driving decision point on the sub-screen P in addition to the main screen in this way, the driver can intuitively grasp the situation of the next driving decision point.

### Control Method of Video Preview Navigation System

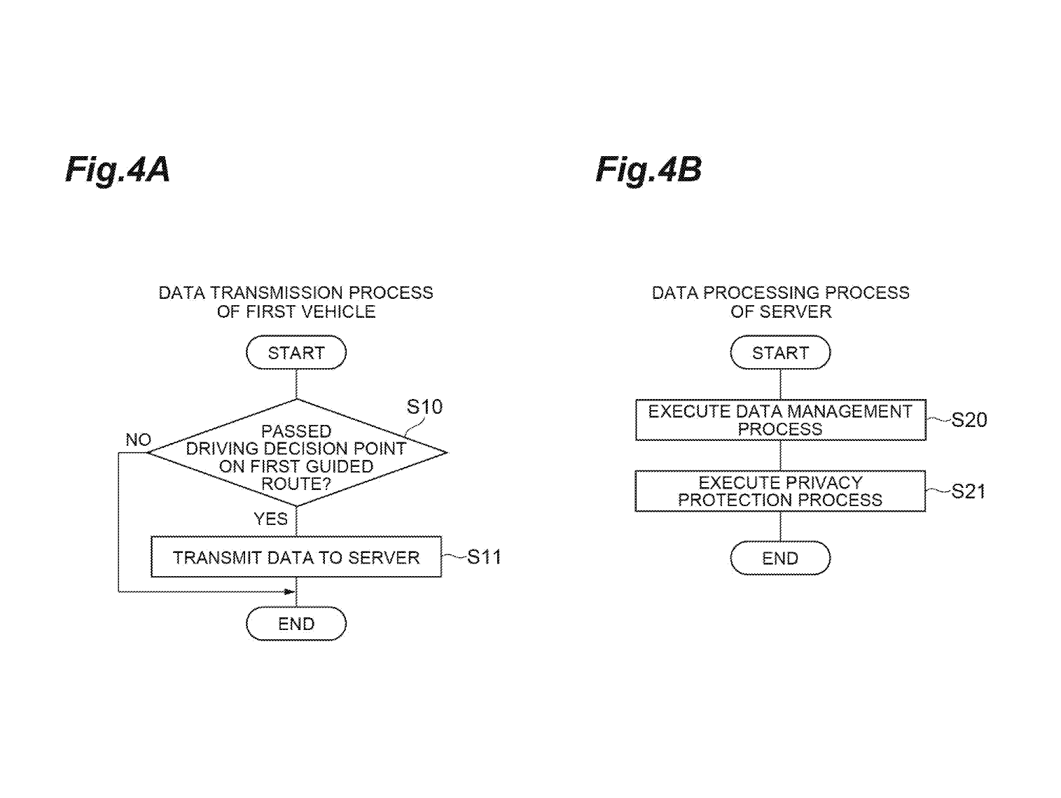

Next, a control method of the video preview navigation system 100 according to the present embodiment will be described with reference to the drawings. FIG. 4A is a flowchart illustrating an example of a data transmission process of a first vehicle.

First, the data transmission process of the first vehicle shown in FIG. 4A will be described. This process shows a procedure for transmitting video data to the server 10 when the first vehicle 2A passes through a driving decision point.

In step S10, the car navigation device 20 of the first vehicle 2A determines whether the first vehicle 2A has passed a driving decision point on the first guided route. This determination is made by comparing the current position of the first vehicle with the information of the driving decision point. When the first vehicle has passed the driving decision point (S10: YES), the car navigation device 20 proceeds to step S11.

In step S11, the car navigation device 20 of the first vehicle 2A transmits the video data captured by the front camera 22 of the first vehicle, the information of the driving decision point, and the information of the first guided route to the server 10. This data is received by the data acquisition unit 11a of the server 10 and stored in the video database 50.

On the other hand, when the first vehicle has not passed the driving decision point (S10: NO), the process ends, and data transmission is not performed. In this way, the video data is transmitted to the server 10 only when the first vehicle passes the driving decision point.

FIG. 4B is a flowchart illustrating an example of a data processing process of the server. Next, the data processing process of the server shown in FIG. 4B will be described. This process shows a procedure for executing data processing on the video data received by the server 10.

In step S20, the data acquisition unit 11a of the server 10 executes a data management process. In this process, the received video data is appropriately managed and stored in the database.

Next, in step S21, the data acquisition unit 11a executes a privacy protection process. In this process, privacy information included in the video data is detected and deleted. A metadata addition process and a filtering process may also be executed together. When the privacy protection process is completed, the process ends. Thereby, the video data is made ready to be provided to the second vehicle 2B in a state where the privacy information is appropriately protected. Alternatively, the data providing unit 11b may perform the privacy protection process instead of the data acquisition unit 11a.

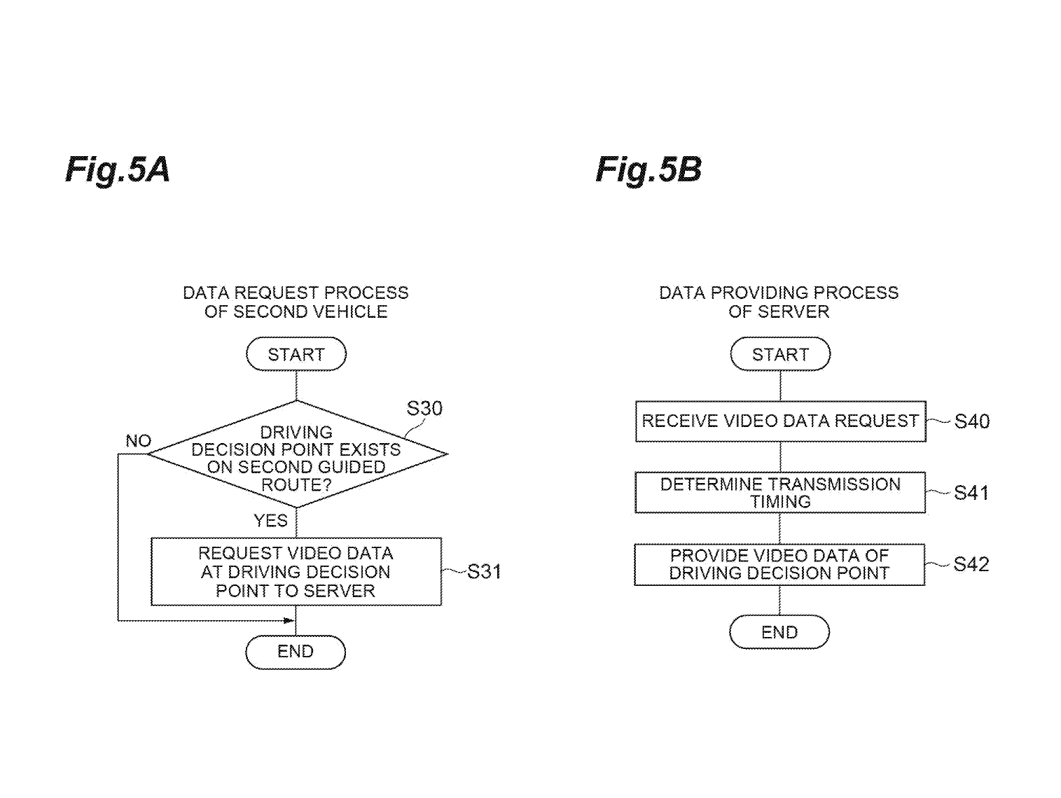

FIG. 5A is a flowchart illustrating an example of a data request process of the second vehicle 2B. The data request process of the second vehicle 2B shown in FIG. 5A will be described. This process shows a procedure for making a request for video data to the server 10 when the second vehicle 2B is heading toward a driving decision point.

In step S30, the car navigation device 20 of the second vehicle 2B determines whether a driving decision point exists on the second guided route. This determination is made based on the current position of the second vehicle 2B and the guided route information. When a driving decision point exists on the guided route of the second vehicle 2B (S30: YES), the car navigation device 20 proceeds to step S31.

In step S31, the second vehicle 2B makes a request to the server 10 for video data at the driving decision point. This request includes, for example, information such as the current position of the second vehicle 2B and the estimated time of arrival.

On the other hand, when no driving decision point exists on the guided route of the second vehicle 2B (S30: NO), the process ends, and no data request is made. In this way, a request for video data is made only when the second vehicle 2B is heading toward a driving decision point.

FIG. 5B is a flowchart illustrating an example of a data providing process of the server. Next, the data providing process of the server shown in FIG. 5B will be described. This process shows a procedure in which the server 10 receives a data request from the second vehicle 2B and provides video data.

In step S40, the server 10 receives a video data request. The request from the second vehicle 2B includes information of the driving decision point, the estimated time of arrival, and the like.

Next, in step S41, the server 10 determines the transmission timing of the video data. This determination is made in consideration of the data size of the video data and the network communication state of the server and the second vehicle 2B. Optimizing the transmission timing ensures that the video data is provided before the second vehicle 2B reaches the driving decision point.

In step S42, the server 10 provides the video data of the driving decision point to the second vehicle 2B. This data is transmitted after a privacy protection process has been applied, so it is provided in a state where the privacy is secured. When the video data is provided to the second vehicle 2B, the process ends.

According to the video preview navigation system 100 according to the present embodiment described above, by acquiring the video data captured by the front camera 22, the information of the driving decision point, and the information of the first guided route when the first vehicle 2A passes through the preset driving decision point on the first guided route, road conditions can be accurately recorded. Furthermore, according to this video preview navigation system 100, when the second vehicle 2B travels on a second guided route that at least partially overlaps with the first guided route, and the overlapping route heads toward a driving decision point where the direction of passage matches, by providing the video data at the driving decision point to the second vehicle 2B, the driver of the second vehicle 2B can visually confirm the situation at the driving decision point in advance.

Therefore, according to this video preview navigation system 100, it is possible to provide video data that can appropriately support the judgment of the driving operation of the driver of the second vehicle 2B at the driving decision point. If specifications such as communication performance are met, it is also possible to provide video data from the first vehicle 2A traveling several tens of meters ahead to the driver of the second vehicle 2B in almost real time.

In addition, according to the video preview navigation system 100, the car navigation device 20 mounted on the second vehicle 2B provides the video data to the driver of the second vehicle 2B in a picture-in-picture mode on the display D of the second vehicle 2B, whereby the driver can visually confirm the situation of the next driving decision point in advance. With the picture-in-picture mode, a video preview is displayed on the sub-screen P simultaneously with normal navigation information displayed on the main screen, so the driver can grasp necessary information at a glance without largely moving his or her line of sight.

In addition, according to the video preview navigation system 100, by the data providing unit 11b executing a privacy protection process to delete privacy information included in the video data before providing the video data to the second vehicle 2B, the privacy of drivers of other vehicles and other road users can be ensured. Specifically, in the privacy protection process, at least the information of the license plate of another vehicle traveling in front of the first vehicle 2A is deleted, so it is possible to prevent personal information of the other vehicle traveling in front of the first vehicle 2A from being inappropriately exposed, which improves the reliability of the system and its acceptance in the market.

Furthermore, according to the video preview navigation system 100, the transmission timing of the video data is adjusted based on the data size of the video data to be provided, the network communication state of the server and the second vehicle 2B, and the predicted time of arrival of the second vehicle 2B at the driving decision point, such that the video data is provided to the second vehicle 2B before the second vehicle 2B reaches the driving decision point. Thereby, it is possible to provide the video data to the second vehicle 2B at an appropriate timing.

Although the embodiments of the present disclosure have been described above, the present disclosure is not limited to the above-described embodiments. The present disclosure can be implemented in various forms with various changes and improvements based on the knowledge of those skilled in the art, including the above-described embodiments.

The video preview navigation system 100 does not necessarily need to perform the privacy protection process. Although the method is not particularly limited, the video data may have a precision that makes it impossible to identify license plates of other vehicles or faces of pedestrians. The video preview navigation system 100 does not need to include the communication vehicles 2, and may be composed only of the server 10.

The video data provided by the server 10 to the second vehicle 2B may be video data that has been significantly processed to suit the second vehicle 2B. For example, the viewpoint may be processed to become video data that considers the eye level of the driver of the second vehicle 2B, based on the difference in vehicle height between the first vehicle 2A and the second vehicle 2B. A virtual representation of the second vehicle may be made to appear in the video data so that it is easy for the driver of the second vehicle 2B to understand. An aspect may be adopted in which elements that do not affect the guidance for the driver of the second vehicle 2B, such as other vehicles in adjacent lanes, are deleted.

What is claimed is:

1. A video preview navigation system comprising a server communicably connected to a plurality of communication vehicles including a first vehicle and a second vehicle, wherein
the server comprises:
a data acquisition unit configured to, when a first guided route is set in the first vehicle and the first vehicle passes through a preset driving decision point on the first guided route, acquire video data captured by a front camera of the first vehicle at the driving decision point, information of the driving decision point, and information of the first guided route; and
a data providing unit configured to, when a second guided route that at least partially overlaps with the first guided route is set in the second vehicle, provide the video data at the driving decision point to the second vehicle when the second vehicle heads toward the driving decision point where an overlapping route has a matching direction of passage.

2. The video preview navigation system according to claim 1, further comprising a car navigation device mounted on the second vehicle and configured to provide the video data to a driver of the second vehicle in a picture-in-picture mode on a display of the second vehicle.

3. The video preview navigation system according to claim 1, wherein the data providing unit executes a privacy protection process to delete privacy information included in the video data before providing the video data to the second vehicle, and
wherein in the privacy protection process, at least information of a license plate of another vehicle traveling in front of the first vehicle is deleted.

4. The video preview navigation system according to claim 1, wherein the data providing unit adjusts a transmission timing of the video data such that the video data at the driving decision point is provided to the second vehicle before the second vehicle reaches the driving decision point, based on a data size of the video data to be provided, a network communication state of the server and the second vehicle, and an estimated time of arrival of the second vehicle at the driving decision point.

5. The video preview navigation system according to claim 1, wherein the driving decision point includes at least one of an entrance of a branch road, an interchange, a roundabout, a multi-lane tunnel, and toll booths provided in each of a plurality of lanes.

6. A control method for a video preview navigation system having a server communicably connected to a plurality of communication vehicles including a first vehicle and a second vehicle, the method comprising:
acquiring, when a first guided route is set in the first vehicle and the first vehicle passes through a preset driving decision point on the first guided route, video data captured by a front camera of the first vehicle at the driving decision point, information of the driving decision point, and information of the first guided route; and
providing, when a second guided route that at least partially overlaps with the first guided route is set in the second vehicle, the video data at the driving decision point to the second vehicle when the second vehicle heads toward the driving decision point where an overlapping route has a matching direction of passage.
